(19) United States
(12) Patent Application Publication
(10) Pub. No.: US 2006/0232554 A1
(43) Pub. Date: Oct. 19, 2006

(54) Scrolling interface for media player

(75) Inventors: Ka-Wei Adrian Wong, Singapore (SG); Boon Keat Eddy Toh, Singapore (SG); Jeng Khim Tan, Singapore (SG); Hock Ho Tee, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd.

(21) Appl. No.: 11/209,292

(22) Filed: Aug. 22, 2005

Related U.S. Application Data
(63) Continuation-in-part of application No. 11/106,903, filed on Apr. 14, 2005.

(51) Int. Cl. G09G 5/08

(52) U.S. Cl. 345/157

(57) ABSTRACT

A media player comprising: (a) a body comprising a front face; (b) a display mounted in the front face; and (c) a scrolling activator mounted in the front face for controlling longitudinal movement of a cursor/selector on the display.

### REFERENCE TO RELATED APPLICATION

This is a continuation-in-part of U.S. patent application Ser. No. 11/106,903 filed 14 Apr. 2005 titled “Method and Apparatus for Touch Scrolling” (our “earlier application’), the contents of which are incorporated herein by reference as if explicitly set forth.

### FIELD OF THE INVENTION

This invention relates to a scrolling interface for a media player and refers particularly, though not exclusively, to such an interface and method for scrolling through and selection within a menu of the media player.

### BACKGROUND TO THE INVENTION

In our earlier application there is described a method and apparatus for touch scrolling in a portable device. In particular it relates to the use of a linear motion on a scrolling activator for track and/or menu control and selection.

When the tracks and/or menu function and/or lists are arranged in a non-linear form (as in a table, plurality of columns, or any array) it can be inconvenient to scroll in one axial direction (e.g. up and down) only and not be able to scroll in the lateral direction (e.g. sideways).

### SUMMARY OF THE INVENTION

According to a first prepared aspect there is provided media player comprising a body comprising a front face; a display mounted in the front face; and a scrolling activator mounted in the front face for controlling longitudinal movement of a censor on the display. The scrolling activator is capable of movement relative to the front face. The movement of the scrolling activator relative to the front face is used for controlling lateral movement of the cursor/selector on the display.

The scrolling activator may be located in an opening in the front face. The movement of the scrolling acticator may be a lateral movement, and the opening maybe of a width that is greater than the scrolling activator. Preferably, the width of the opening is equal to the sum of the width of scrolling activator and a total extent of the lateral movement of the scrolling activator.

The scrolling activator may comprise a main operational top, there being a peripheral rim around the main operational top for extending over the front face; and two substantially L-shaped sides depending from the peripheral rim and arranged in an opposite manner. Each substantially L-shaped side and the peripheral rim may form a substantially U-shaped channel in which the front face locates.

Alternatively, the scrolling activator may be located in an opening in the front face, the front face being bifurcated around the opening to form a groove. The scrolling activator may have a peripheral tongue for engaging in the groove in the manner of a sliding fit. The peripheral tongue may extend completely around the periphery of the scrolling activator, and the groove may extend completely around the opening.

The media player may be an MP3 player, a video player, a digital photo viewer or a combination of the aforementioned.

According to a second aspect the scrolling activator may have switches mounted on each side thereof for controlling lateral movement of the censor on the display. The switches may be mechanical tact switches. The scrolling activator may located in an opening in the front face, the opening being of a width that is as wide as the scrolling activator. Preferably, the scrolling activator comprises a main operational top with a peripheral rim around the main operational top for defining a perimeter of the scrolling activator. It is also preferable that the scrolling activator further comprises two substantially L-shaped sides depending there from and arranged in an opposite manner. Each substantially L-shaped side and the peripheral rim may form a substantially U-shaped channel in which the front face locates. The activator may preferably be supported by a pivot for the enablement of a rocking action by the activator to activate the switches.

### BRIEF DESCRIPTION OF THE DRAWINGS

In order that the present invention may be fully understood and readily put into practical effect, there shall now be described by way of non-limitative example only preferred embodiments of the present invention, the description being with reference to the accompanying illustrative drawings.

In the drawings:

FIG. 1 is a front view of a first embodiment in a first operational position;

FIG. 2 is an end view corresponding to FIG. 1;

FIG. 3 is a view corresponding to FIG. 1 in a second operational position;

FIG. 4 is a view corresponding to FIGS. 1 and 3 in a third operational position;

FIG. 5 is an enlarged, partial, cross-sectional view along the lines and in the direction of arrows 5-5 on FIG. 1;

FIG. 6 is a view corresponding to FIG. 1 of a second embodiment;

FIG. 7 is a view corresponding to FIG. 1 of a third embodiment;

FIG. 8 is a view corresponding to FIG. 4 of a fourth embodiment; and

FIG. 9 is a view corresponding to FIG. 6 of a second embodiment.

### DETAILED DESCRIPTION OF THE PREFERRED EMBODIMENTS

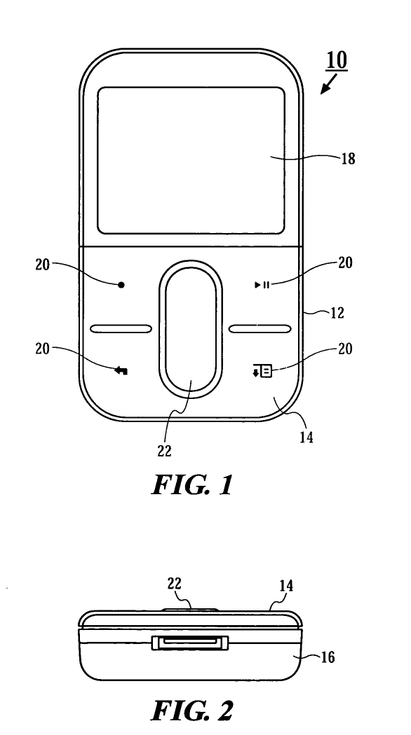

To first refer to FIGS. 1 and 2, there is shown a media player 10 such as that shown in our earlier application. In the form illustrated, it is an MP3 player, but it may be any form of portable device capable of media reproduction such as, for example, a video player, a digital photo viewer and a combination of the aforementioned.

The media player 10 has a body 12 with a front face 14 and an end wall 16; as well as side walls (not shown), base (not shown) and top wall (not shown). In front face 14 are: a display 18, functional controls 20, and a scrolling activator 22 such as that disclosed in our earlier application.

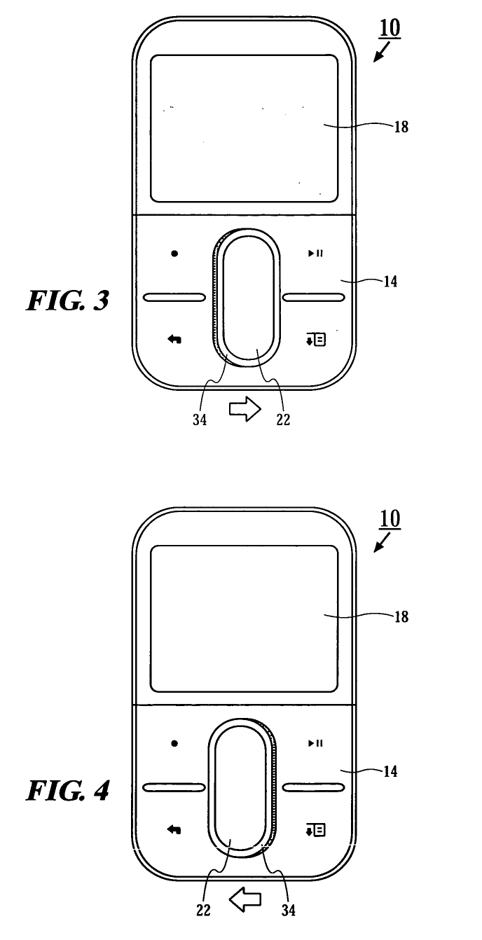

Referring now to FIGS. 3 to 5, the operation of the scrolling activator 22 will be described. The scrolling activator 22 is mounted to front face 14 for movement relative thereto laterally of the scrolling direction within scrolling activator 22. With the scrolling activator 22 arranged longitudinally of the front face as is shown, the scrolling activator 22 may be moved to the right (FIG. 3) relative to the front face 14, or to the left (FIG. 4) relative to the front face 14. For this to be able to be done, front face 14 has an opening 24 therethrough that is wider than the scrolling activator 22. Preferably the opening is as wide as the scrolling activator 22 plus the total lateral movement of the scrolling activator.

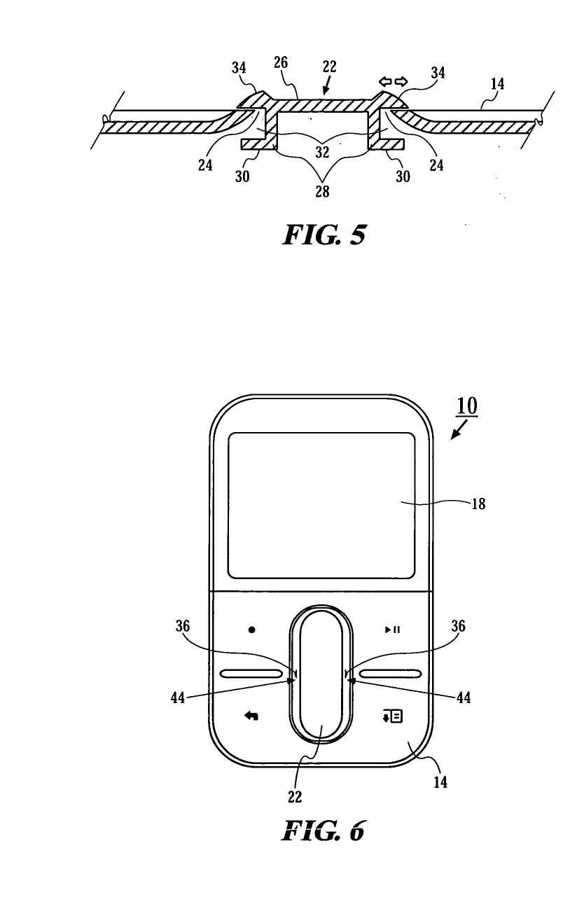

As shown in FIG. 5, the scrolling activator 22 has a main, operational top 26 has two substantially L-shaped sides 28 depending therefrom and arranged in an opposite manner such that the web portions 30 of each side 28 face away from each other. This creates a channel 32 extending the length of each side 28 of the scrolling activator 22 and in which the front face is received. The top 26 also has a peripheral rim 34 that locates above the front face 14 and preferably is slidably mounted on front face 14. The rim 34 and sides 28 form channels 32 into a U-shape.

The rim 34 extends outwardly from top 26 for a distance at least as great as the total lateral movement—the total lateral distance from the position shown in FIG. 3 to the position shown in FIG. 4. In this way the rim 34 is always over the front face 14 for the entire periphery of top 26 so that opening 24 is not exposed. This assists in the reduction of the introduction through opening 24 of unwanted contaminants.

Preferably, the scrolling activator 22 has three defined position—right (FIG. 3), left (FIG. 4) and centre (FIG. 1). These are also shown in partial relief on FIG. 5. These may be defined by physical means such as, for example, dimples/projections on scrolling activator 22 and/or front face 14; or due to electrical switch pre-set conditions.

The scrolling activator 22 can control scrolling laterally on the display 18 by the movement described above. The sensing of the movement may be by sensors (not shown); by a joystick (not shown) connected to scrolling activator 22; or by any other suitable or known motion detector.

If desired, seals (not shown) may be provided between rim 34 and front face 14 and/or between sides 28 and front face 14.

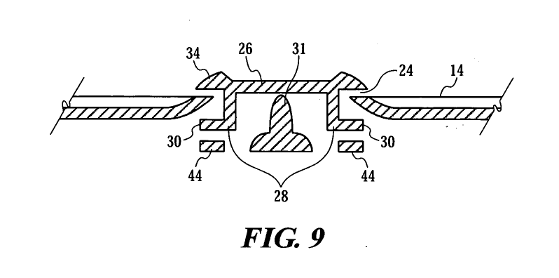

FIG. 6 shows a second embodiment where instead of scrolling activator 22 being moveable laterally relative to front face 14, mechanical tact switches 44 are provided on each side of the scrolling activator 22, the switches being able to be activated by application of pressure on the directional arrows 36. In such an embodiment, the scrolling activator 22 functions like a rocker switch. As shown in FIG. 9, the scrolling activator 22 has a main, operational top 26 has two substantially L-shaped sides 28 depending therefrom and arranged in an opposite manner such that the web portions 30 of each side 28 face away from each other. The scrolling activator 22 rocks about a pivot 31. The top 26 preferably has a peripheral rim 34 that does not overlap front face 14 and defines a perimeter of the scrolling activator 22. The front face 14 may have an opening 24 therethrough that is as wide as the scrolling activator 22. In this embodiment, there is little or no lateral movement of the scrolling activator 22. The switches 44 are activated once the web portions 30 of the activator 22 contact them.

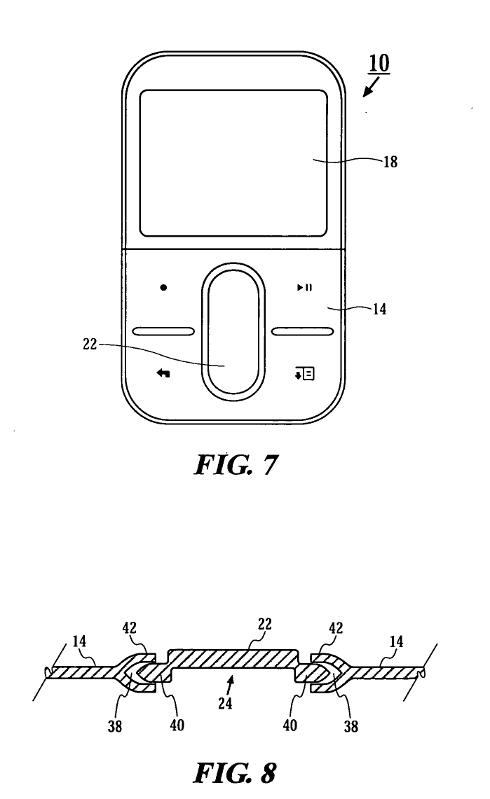

For FIG. 7, the lateral movement is by lateral scrolling within the scrolling activator 22 in the same manner as the longitudinal scrolling of our earlier application.

Naturally, the relationship between the front face 14 and the scrolling activator 22 may be reversed. FIG. 5 shows the scrolling activator 22 sliding on the front face 14 while FIG. 8 shows the scrolling activator 22 sliding within the front face 14.

FIG. 8 shows the front face 14 having a bifurcated portion 42 around the periphery of opening 24 to form a groove 38. The scrolling activator has a peripheral tongue 40 that engages in the groove 38 in the manner of a sliding fit. This eliminates the need for sides 28. In this embodiment, the opening 24 and scrolling activator 22 will be more of a rectangular shape than the elliptical shape shown in FIGS. 1 to 7. In all other respects the structure and operation will be the same as for FIGS. 1 to 7.

The tongue 40 may be on the sides only of scrolling activator 22, and thus the groove 38 may be only on the sides of opening 24. Alternatively, the tongue may extend around the complete periphery of scrolling activator 22 and thus the groove 38 will extend around the complete periphery of opening 24.

It is preferable that the size and shape of the tongue 40 corresponds to the size and shape of the groove 38 for smooth operation. Preferably the groove 38 tapers outwardly (i.e. is of greater height) towards the opening 24. Furthermore, a combination of the form of FIG. 5 with that of FIG. 8 may be used.

In the embodiments of FIGS. 1 to 5 and 8, the lateral movement of the scrolling activator 22 causes lateral movement of the cursor/selector on the like of display 18, and the scrolling activator 22 is for longitudinal movement of the cursor/selector in the manner of our earlier application. In the embodiments of FIGS. 6 and 9, lateral movement of the cursor/selector on the like of display 18 may also be invoked by applying a force to the left/right sides of the peripheral rim 34 of the scrolling activator 22.

Whilst there has been described in the foregoing description preferred embodiments of the present invention, it will be understood by those skilled in the technology concerned that many variations or modifications in details of design or construction may be made without departing from the present invention.

1. A media player comprising:
(a) a body comprising a front face;
(b) a display mounted in the front face;
(c) a scrolling activator mounted in the front face for controlling longitudinal movement of a cursor/selector on the display;
(d) the scrolling activator being mounted for movement of the scrolling activator relative to the front face for controlling lateral movement of the cursor/selector on the display.

2. A media player as claimed in claim 1, wherein the scrolling activator is located in an opening in the front face, the opening is of a width that is greater than the scrolling activator.

3. A media player as claimed in claim 2, wherein movement of the scrolling activator is lateral; the width of the opening being equal to the sum of the width of scrolling activator and a total extent of the lateral movement of the scrolling activator.

4. A media player as claimed in claim 1, wherein the scrolling activator comprises a main operational top, there being a peripheral rim around the main operational top for extending over the front face.

5. A media player as claimed in claim 4, the scrolling activator further comprising two substantially L-shaped sides depending there from and arranged in an opposite manner.

6. A media player as claimed in claim 5, wherein each substantially L-shaped side and the peripheral rim form a substantially U-shaped channel in which the front face locates.

7. A media player as claimed in claim 1, wherein the scrolling activator is located in an opening in the front face, the front face being bifurcated around the opening to from a groove, the scrolling activator having a peripheral tongue for engaging in the groove in the manner of a sliding fit.

8. A media player as claimed in claim 7, wherein the peripheral tongue extends completely around the periphery of the scrolling activator, and the groove extends completely around the opening.

9. A media player as claimed in claim 1, wherein the media player is selected from the group comprising: an MP3 player, a video player, a digital photo viewer and a combination of the aforementioned.

10. A media player comprising:
(a) a body comprising a front face;
(b) a display mounted in the front face;
(c) a scrolling activator mounted in the front face for controlling longitudinal movement of a cursor/selector on the display;
(d) the scrolling activator having switches mounted on each side thereof for controlling lateral movement of the cursor/selector on the display.

11. A media player as claimed in claim 10, wherein the switches are mechanical tact switches.

12. A media player as claimed in claim 10, wherein the scrolling activator is located in an opening in the front face, the opening is of a width that is as wide as the scrolling activator.

13. A media player as claimed in claim 10, wherein the scrolling activator comprises a main operational top, there being a peripheral rim around the main operational top for defining a perimeter of the scrolling activator.

14. A media player as claimed in claim 13, wherein the scrolling activator further comprises two substantially L-shaped sides depending there from and arranged in an opposite manner.

15. A media player as claimed in claim 14, wherein each substantially L-shaped side and the peripheral rim form a substantially U-shaped channel in which the front face locates.

16. A media player as claimed in claim 10, wherein the scrolling activator is located in an opening in the front face, the activator being supported by a pivot for the enablement of a rocking action by the activator to activate the switches.

17. A media player as claimed in claim 10, wherein the media player is selected from the group comprising: an MP3 player, a video player, a digital photo viewer and a combination of the aforementioned.
